(19) United States
(12) Patent Application Publication
(10) Pub. No.: US 2016/0032139 A1
(43) Pub. Date: Feb. 4, 2016

(54) HARD COAT FILM AND METHOD FOR MANUFACTURING SAME

(71) Applicant: DAICEL CORPORATION, Osaka-shi, Osaka (JP)

(72) Inventors: Shinji KIKUCHI, Amagasaki-shi (JP); Daisuke ITO, Amagasaki-shi (JP)

(73) Assignee: DAICEL CORPORATION, Osaka-shi, Osaka (JP)

(21) Appl. No.: 14/780,078

(22) PCT Filed: Mar. 26, 2014
(86) PCT No.: PCT/JP2014/058527

§ 371 Date: Sep. 25, 2015

(30) Foreign Application Priority Data
Mar. 27, 2013 (JP) 2013-066179

(51) Int. Cl. C09D 163/00; B05D 3/00

(52) U.S. Cl. CPC C09D 163/00; B05D 3/007

(57) ABSTRACT

Provided is a hard coat film including a hard coat layer that has high pencil hardness and high scratch resistance and still offers excellent transparency.

The present invention relates to a hard coat film including a plastic substrate and a hard coat layer disposed on or over at least one surface of the plastic substrate. The hard coat layer is formed from a curable composition including 3,4,3′,4′-diepoxybicyclohexyl, at least one selected from the group consisting of hydroxy-containing silicon compounds and silica fillers, and an acid generator.

### TECHNICAL FIELD

The present invention relates to a hard coat film including a hard coat layer as a surface layer; and to a method for producing the hard coat film. The present application claims priority to Japanese Patent Application No. 2013-066179 filed to Japan on Mar. 27, 2013, the entire contents of which are incorporated herein by reference.

### BACKGROUND ART

A variety of hard coat films has been used in order to impart high surface hardness and/or high scratch resistance to surfaces of various products and members (components). Predominantly and widely known hard coat films of this type are those each having a laminate structure including a substrate and a hard coat layer disposed on a surface of the substrate.

Known representative hard coat layers to constitute the hard coat films include a hard coat layer formed by radical polymerization of a multifunctional acrylic monomer through ultraviolet irradiation. Known hard coat films including a hard coat layer of this type include a hard coat film as described in Patent Literature (PTL) 1. The hard coat film includes a base film, and a coating layer disposed on at least one side of the base film, where the coating layer is formed from a resin composition including 100 parts by weight of an ultraviolet-curable acrylate resin, and 0.1 to 10 parts by weight of an ultraviolet-curable silicone resin having a molecular weight of 500 to 20000.

### CITATION LIST

### Patent Literature

PTL 1: Japanese Unexamined Patent Application Publication (JP-A) No. 2005-262597

### SUMMARY OF INVENTION

### Technical Problem

Such hard coat layers formed by radical polymerization of multifunctional acrylic monomers as above generally have pencil hardness of about 3H, but may require a higher pencil hardness in some uses. The hard coat layers are known to have a higher pencil hardness generally when they have a larger thickness. Disadvantageously, however, the hard coat layers, if having a larger thickness, suffer from cracking by cure shrinkage upon the formation of the hard coat layers; namely, it is difficult for the hard coat layers to have a higher pencil hardness by having a larger thickness.

Hard coat layers are recently increasingly requiring excellent transparency (in particular a low haze). This is required so as not to adversely affect the design of objective articles (adherends) to which the hard coat films are applied or the design of substrates of the hard coat films, or so as to use the hard coat films typically as display protecting sheets.

Accordingly, the present invention has an object to provide a hard coat film and a method for producing the hard coat film, where the hard coat film includes a hard coat layer that has high pencil hardness and still offers excellent transparency.

The present invention has another object to provide a hard coat film that has high pencil hardness and high scratch resistance and still offers excellent transparency.

### Solution to Problem

After intensive investigations to achieve the objects, the present inventors have found a hard coat layer that is formed from a curable composition (hard-coating agent) including a specific epoxy compound, a specific silicon-containing compound and/or a silica filler, and an acid generator. They have found that this hard coat layer has high pencil hardness and high scratch resistance and still offers excellent transparency; and that the hard coat layer, even when having a large thickness, does not suffer from defects such as crack formation, and can thereby have a significantly higher pencil hardness. The present inventors also have found another specific hard coat layer that has ratios between specific absorption peaks in a surface ATR-IR spectrum being controlled within specific ranges and has specific surface elements as analyzed by ESCA. They have found that this hard coat layer has high pencil hardness, offers excellent transparency, still does not suffer from defects such as crack formation even when having a large thickness, and can thereby have a significantly higher pencil hardness. The present invention has been made based on these findings.

Specifically, the present invention provides, in an embodiment, a hard coat film including a plastic substrate and a hard coat layer disposed on or over at least one surface of the plastic substrate.

The hard coat layer is formed from a curable composition including 3,4,3′,4′-diepoxybicyclohexyl, at least one selected from the group consisting of hydroxy-containing silicon compounds and silica fillers, and an acid generator.

In the hard coat film, the hard coat layer may have a thickness of 20 μm or more.

The hard coat layer in the hard coat film may include surface elements including silicon and at least one element selected from the group consisting of sulfur, phosphorus, fluorine, and antimony, where the surface elements are analyzed by ESCA of a surface of the hard coat layer.

The hard coat film may have a haze of 1.5% or less.

The present invention also provides, in another embodiment, a method for producing the hard coat film. The method includes the steps of applying a curable composition to a surface of a plastic substrate, and curing the applied curable composition. The curable composition includes 3,4,3′,4′-diepoxybicyclohexyl, at least one selected from the group consisting of hydroxy-containing silicon compounds and silica fillers, and an acid generator.

The present invention further provides, in yet another embodiment, a hard coat film including a plastic substrate and a hard coat layer disposed on or over at least one surface of the plastic substrate.

The hard coat layer has a ratio a2/a1 of 0.1 or less and a ratio a3/a1 of 0.1 or less, where, in an ATR-IR spectrum of a surface of the hard coat layer, a1 represents an absorbance of an absorption peak assigned to an ether bond C—O stretching vibration; a2 represents an absorbance of an absorption peak assigned to an ester bond C═O stretching vibration; and a3 represents an absorbance of an absorption peak assigned to an aromatic C—H out-of-plane bending vibration.

The hard coat layer includes surface elements including at least one element selected from the group consisting of sulfur, phosphorus, fluorine, and antimony, where the surface elements are analyzed by ESCA of a surface of the hard coat layer.

In the hard coat film, the surface elements may further include silicon, where the surface elements are analyzed by ESCA of the surface of the hard coat layer.

Specifically, the present invention relates to followings.

[1] The present invention relates to a hard coat film including a plastic substrate and a hard coat layer disposed on or over at least one surface of the plastic substrate. The hard coat layer is formed from a curable composition including 3,4,3′,4′-diepoxybicyclohexyl, at least one selected from the group consisting of hydroxy-containing silicon compounds and silica fillers, and an acid generator.

[2] In the hard coat film according to [1], the plastic substrate may have a thickness of 0.01 to 10000 μm.

[3] In the hard coat film according to one of [1] and [2], the curable composition may contain 3,4,3′,4′-diepoxybicyclohexyl in a content of 70 to 99 percent by weight based on the total amount (100 percent by weight) of non-volatile matter in the curable composition.

[4] In the hard coat film according to any one of [1] to [3], the hydroxy-containing silicon compound may include at least one selected from the group consisting of polyether-modified polysiloxanes, polyester-modified polysiloxanes, and silicon-modified acrylic resins.

[5] In the hard coat film according to any one of [1] to [4], the curable composition may contain the hydroxy-containing silicon compound(s) in a content of 0.1 to 10 parts by weight per 100 parts by weight of 3,4,3′,4′-diepoxybicyclohexyl.

[6] In the hard coat film according to any one of [1] to [5], the silica filler(s) may have an average particle diameter of 1 to 300 nm.

[7] In the hard coat film according to any one of [1] to [6], the curable composition may contain the silica filler(s) in a content of 5 to 60 parts by weight per 100 parts by weight of 3,4,3′,4′-diepoxybicyclohexyl.

[8] In the hard coat film according to any one of [1] to [7], the acid generator may include a photoacid generator including a fluoroalkyl-containing anionic moiety and a cationic moiety.

[9] In the hard coat film according to [8], the fluoroalkyl-containing anionic moiety may be selected from a fluoroalkylfluorophosphate ion, CF₃SO₃—, C₄F₉SO₃—, and B(C₆F₅)₄—, where the fluoroalkylfluorophosphate ion is represented by Formula (2):

[(Rf)ₙPF₆₋ₙ]⁻ (2)

where Rf represents a C₁-C₄ alkyl group (fluoroalkyl group) with 80% or more of whose hydrogen atoms being substituted with fluorine atoms; and n represents an integer of 1 to 5.

[10] In the hard coat film according to any one of [1] to [9], the curable composition may contain the acid generator in a content of 0.1 to 10 parts by weight per 100 parts by weight of 3,4,3′,4′-diepoxybicyclohexyl.

[11] In the hard coat film according to any one of [1] to [10], the hard coat layer may have a thickness of 20 μm or more.

[12] In the hard coat film according to any one of [1] to [11], the hard coat layer may have a haze of 1.5% or less at a thickness of 30 μm.

[13] In the hard coat film according to any one of [1] to [12], the hard coat layer may have a total luminous transmittance of 85% or more at a thickness of 30 μm.

[14] The hard coat film according to any one of [1] to [13] may have a thickness of 0.01 to 10000 μm.

[15] In the hard coat film according to any one of [1] to [14], the hard coat layer surface may have pencil hardness of 3H or higher.

[16] In the hard coat film according to any one of [1] to [15], the hard coat layer may include surface elements including silicon and at least one element selected from the group consisting of sulfur, phosphorus, fluorine, and antimony, where the surface elements are analyzed by ESCA of a surface of the high-temperature.

[17] The hard coat film according to any one of [1] to [16] may have a haze of 1.5% or less.

[18] The hard coat film according to any one of [1] to [17] may have a total luminous transmittance of 85% or more.

[19] The present invention also relates to a method for producing the hard coat film according to any one of [1] to [18]. The method includes the steps of applying a curable composition to a surface of a plastic substrate, and curing the applied curable composition, where the curable composition includes 3,4,3′,4′-diepoxybicyclohexyl, at least one selected from the group consisting of hydroxy-containing silicon compounds and silica fillers, and an acid generator.

[20] The present invention further relates to a hard coat film including a plastic substrate, and a hard coat layer disposed on or over at least one surface of the plastic substrate.

The hard coat layer has a ratio a2/a1 of 0.1 or less and a ratio a3/a1 of 0.1 or less, where, in an ATR-IR spectrum of a surface of the hard coat layer, a1 represents an absorbance of an absorption peak assigned to an ether bond C—O stretching vibration; a2 represents an absorbance of an absorption peak assigned to an ester bond C═O stretching vibration; and a3 represents an absorbance of an absorption peak assigned to an aromatic C—H out-of-plane bending vibration.

In addition, the hard coat layer includes surface elements including at least one element selected from the group consisting of sulfur, phosphorus, fluorine, and antimony, where the surface elements are analyzed by ESCA of a surface of the hard coat layer.

[21] In the hard coat film according to [20], the surface elements may further include silicon, where the surface elements are analyzed by ESCA of the surface of the hard coat layer.

[22] In the hard coat film according to one of [20] and [21], the plastic substrate may have a thickness of 0.01 to 10000 μm.

[23] In the hard coat film according to any one of [20] to [22], the hard coat layer may have a thickness of 20 μm or more.

[24] In the hard coat film according to any one of [20] to [23], the hard coat layer may have a haze of 1.5% or less at a thickness of 30 μm.

[25] In the hard coat film according to any one of [20] to [24], the hard coat layer may have a total luminous transmittance of 85% or more at a thickness of 30 μm.

[26] The hard coat film according to any one of [20] to [25] may have a thickness of 0.01 to 10000 μm.

[27] In the hard coat film according to any one of [20] to [26], the hard coat layer surface may have pencil hardness of 3H or higher.

[28] The hard coat film according to any one of [20] to [27] may have a haze of 1.5% or less.

[29] The hard coat film according to any one of [20] to [28] may have a total luminous transmittance of 85% or more.

### Advantageous Effects of Invention

The hard coat layer in the hard coat film according to the present invention has the configuration as above, thereby has high pencil hardness (or high pencil hardness and high scratch resistance), and still offers excellent transparency. Assume that the hard coat film according to the present invention typically employs, as the plastic substrate, one having excellent transparency (transparent substrate). The hard coat film in this case can act as a hard coat film that has high pencil hardness (or have high pencil hardness and high scratch resistance) and still offers excellent transparency. The hard coat film according to the present invention is resistant to defects such as crack formation even when the hard coat layer has a large thickness. The hard coat film can thereby have significantly high pencil hardness by allowing the hard coat layer to have a large thickness.

### BRIEF DESCRIPTION OF DRAWINGS

FIG. 1 is the ATR-IR spectrum chart of a hard coat film obtained in Example 5.

### DESCRIPTION OF EMBODIMENTS

### Hard Coat Film

A hard coat film according to an embodiment of the present invention includes a plastic substrate, and a hard coat layer disposed on or over at least one surface of the plastic substrate. The hard coat layer in the hard coat film according to the embodiment of the present invention is formed from a curable composition including a component A, a component B, and a component C as essential components. The component A refers to 3,4,3′,4′-diepoxybicyclohexyl. The component B refers to at least one selected from the group consisting of hydroxy-containing silicon compounds and silica fillers. The component C refers to an acid generator. This curable composition is also referred to as a “curable composition for use in the present invention”. The hard coat layer formed from the curable composition for use in the present invention is herein also referred to as a “hard coat layer [1] in the present invention”. In particular, the hard coat film including a plastic substrate and the hard coat layer [1] in the present invention disposed on or over at least one surface of the plastic substrate is also referred to as a “hard coat film [1] according to the present invention”.

In another embodiment, the hard coat film according to the present invention is also specified as a hard coat film as follows. In particular, this hard coat film is also referred to as a “hard coat film [2] according to the present invention”.

The hard coat film [2] according to the present invention includes a plastic substrate, and a hard coat layer disposed on or over at least one surface of the plastic substrate. The hard coat layer has a ratio a2/a1 of 0.1 or less and a ratio a3/a1 of 0.1 or less, where the ratios are calculated from absorbances a1, a2, and a3 as follows in an ATR-IR spectrum of the surface of the hard coat layer. In addition, the hard coat layer includes surface elements including at least one element selected from the group consisting of sulfur, phosphorus, fluorine, and antimony, where the surface elements are analyzed by ESCA of the hard coat layer surface. The absorbances a1, a2, and a3 are expressed as follows:

a1 represents the absorbance of an absorption peak assigned to an ether bond C—O stretching vibration;

a2 represents the absorbance of an absorption peak assigned to an ester bond C═O stretching vibration; and

a3 represents the absorbance of an absorption peak assigned to an aromatic C—H out-of-plane bending vibration.

The hard coat layer in the hard coat film [2] according to the present invention is also referred to as a “hard coat layer [2] in the present invention”.

In the present description, the “hard coat film [1] according to the present invention” and the “hard coat film [2] according to the present invention” are also generically referred to as a “hard coat film according to the present invention”. Likewise, the “hard coat layer [1] in the present invention” and the “hard coat layer [2] in the present invention” are also generically referred to as a “hard coat layer in the present invention”.

The hard coat layer in the present invention in the hard coat film according to the present invention may be disposed on or over only one surface (only one side) or both surfaces (both sides) of the plastic substrate.

The hard coat layer in the present invention in the hard coat film according to the present invention may be disposed only partially or entirely on or over one or both sides of the plastic substrate.

Plastic Substrate

The “plastic substrate” in the hard coat film according to the present invention refers to a portion acting as a substrate (base) of the hard coat film and being other than the hard coat layer in the present invention. The plastic substrate usable herein can be selected from known or common substrates each including a plastic material and is not limited.

The plastic material constituting the plastic substrate is exemplified by, but not limited to, a variety of plastic materials including polyesters such as poly(ethylene terephthalate)s (PETs) and poly(ethylene naphthalate)s (PENs); polyimides; polycarbonates; polyamides; polyacetals; poly(phenylene oxide)s; poly(phenylene sulfide)s; polyethersulfones; poly(ether ether ketone)s; cyclic polyolefins such as homopolymers (e.g., addition polymers and ring-opening polymers) of norbornene monomers, copolymers (e.g., cyclic olefin copolymers such as addition polymers and ring-opening polymers) of a norbornene monomer and an olefinic monomer, such as norbornene-ethylene copolymers, and derivatives of them; vinyl polymers such as acrylic resins, polystyrenes, and poly(vinyl chloride)s; vinylidene polymers such as poly(vinylidene chloride)s; epoxy resins; phenolic resins; melamine resins; urea resins; maleimide resins; and silicones. The plastic substrate may include only one plastic material, or two or more different plastic materials. The plastic substrate may further includes, as an additional component, one or more materials (e.g., metals) other than the plastic materials.

Among them, preferred as the plastic substrate are substrates having excellent transparency (transparent substrates), and more preferred are polyester films (in particular PET films and PEN films) and cyclic polyolefin films. These are preferred for obtaining a hard coat film having excellent transparency as the hard coat film according to the present invention.

The plastic substrate may further include one or more other additives as needed. Such additives are exemplified by antioxidants, ultraviolet absorbers, photostabilizers, thermal stabilizers, crystal nucleators, flame retardants, flame retardant promotors, fillers, plasticizers, impact modifiers, reinforcers, dispersing agents, antistatic agents, blowing agents, and antimicrobial agents. The plastic substrate may include each of different additives alone or in combination.

The plastic substrate may have a single-layer structure or a multilayer (laminated) structure and may have any configuration (structure). For example, the plastic substrate may be a plastic substrate having a multilayer structure including a plastic film and, disposed on at least one side of the plastic film, a layer other than the hard coat layer in the present invention. The layer other than the hard coat layer in the present invention is also referred to as an “other layer”. The multilayer structure is exemplified by a structure of “(plastic film)/(other layer)” and a structure of “(other layer)/(plastic film)/(other layer)”. The other layer is exemplified by hard coat layers other than the hard coat layer in the present invention. A material constituting the other layer is exemplified by the above-mentioned plastic materials.

The plastic substrate may undergo a known or common surface treatment partially or entirely on the surface(s). The surface treatment is exemplified by roughening treatment, adhesion facilitating treatment, antistatic treatment, sand blasting (sand matting), corona discharge treatment, plasma treatment, chemical etching, water matting, flame treatment, acid treatment, alkaline treatment, oxidation, ultraviolet irradiation treatment, and silane coupling agent treatment. The plastic substrate may be an unstretched film (unoriented film) or a stretched film (e.g., uniaxially stretched film or biaxially stretched film).

The plastic substrate may be produced by a known or common method. Typically, the plastic material is formed into a film, and this is used as the plastic substrate (plastic film). Where necessary, an appropriate layer (e.g., the other layer) may be formed on or over the plastic film, and/or the plastic film may further be subjected to an appropriate surface treatment. The plastic substrate for use herein may also be selected from commercial products.

The plastic substrate may have a thickness that is not critical, but can be selected as appropriate typically within the range of 0.01 to 10000 μm.

Hard Coat Layer in Present Invention

The hard coat layer in the present invention is a layer constituting at least one of surface layers in the hard coat film according to the present invention. In particular, the hard coat layer [1] in the present invention is a layer (cured product layer) including a cured product (resin cured product) prepared by curing the curable composition for use in the present invention.

Curable Composition

The curable composition for use in the present invention is a composition to form the hard coat layer [1] in the present invention and is also referred to typically as a “hard-coating agent” or a “hard-coating liquid”. The curable composition for use in the present invention includes the components A, B, and C as essential components, as described above.

Component A

The component A in the curable composition for use in the present invention is 3,4,3′,4′-diepoxybicyclohexyl. The curable composition for use in the present invention, as including the component A as an essential component, can impart high pencil hardness, high scratch resistance, and excellent transparency to the hard coat layer in the present invention.

The 3,4,3′,4′-diepoxybicyclohexyl can be prepared by any known or common method not limited, but may be prepared by a method described typically in JP-A No. 2008-031424. The 3,4,3′,4′-diepoxybicyclohexyl for use herein may also be selected from commercial products.

The curable composition for use in the present invention may contain 3,4,3′,4′-diepoxybicyclohexyl in a content (blending proportion) not critical, but preferably 70 to 99 percent by weight, more preferably 75 to 98 percent by weight, and furthermore preferably from greater than 80 percent by weight to 98 percent by weight, based on the total amount (100 percent by weight) of non-volatile matter in the curable composition. The curable composition, if containing 3,4,3′,4′-diepoxybicyclohexyl in a content less than 70 percent by weight, may cause the hard coat layer to have pencil hardness and/or scratch resistance at insufficient level. In contrast, the curable composition, if containing 3,4,3′,4′-diepoxybicyclohexyl in a content greater than 99 percent by weight, causes relatively smaller contents of the component B and the component C. This may cause the hard coat layer to have insufficient scratch resistance and/or a poor appearance. The term “non-volatile matter in the curable composition” refers to components (residual components) that remain (as intact or as reacted) as constituents of the hard coat layer upon the formation of the hard coat layer. The residual components are generally components of the curable composition, excluding a solvent. The residual components can be measured typically in conformity to Method 1 for the Drying Loss Testing prescribed in JIS K 0067.

Component B

The component B in the curable composition for use in the present invention includes at least one selected from the group consisting of hydroxy-containing silicon compounds and silica fillers. The curable composition for use in the present invention, as including the component B as an essential component, can impart high pencil hardness and high scratch resistance to the hard coat layer in the present invention.

The term “hydroxy-containing silicon compounds” refers to silicon compounds each including at least one hydroxy group per molecule, where the term “silicon compounds” refers to compounds each including at least a silicon atom. The hydroxy-containing silicon compounds are exemplified by siloxane compounds including one or more hydroxy groups per molecule. The term “siloxane compounds” refers to compounds including a siloxane bond (Si—O—Si bond).

Specifically, the hydroxy-containing silicon compounds are exemplified by hydroxy-containing polysiloxanes such as hydroxy-containing polydimethylsiloxanes; hydroxy-containing modified polysiloxanes such as hydroxy-containing modified polydimethylsiloxanes; and siloxane-modified hydroxy-containing compounds (siloxane-modified derivatives of non-siloxane compounds) derived from non-siloxane compounds such as acrylic polymers (acrylic resins).

The hydroxy-containing modified polysiloxanes are exemplified by polyether-modified polysiloxanes corresponding to polysiloxanes (e.g., polydimethylsiloxanes), except for a polyether chain being introduced; and polyester-modified polysiloxanes corresponding to polysiloxanes, except for a polyester chain being introduced. The polyether chain is exemplified by poly(alkylene oxide) chains such as poly(ethylene oxide) chain, poly(propylene oxide) chain, and poly(ethylene oxide/propylene oxide) chain. The hydroxy-containing modified polysiloxanes may include the polyether chain and/or polyester chain as introduced at any position not limited. For example, the polyether chain and/or polyester chain may be introduced in the side chain, or as part of the principal chain, of the polysiloxane chain. The hydroxy-containing modified polysiloxanes may each include hydroxy group(s) at any position(s) not limited, such as in the polysiloxane moiety or in the modifying moiety (e.g., the polyether chain and/or polyester chain). The hydroxy-containing modified polysiloxanes may each include hydroxy group(s) in a number not critical, as long as being one or more.

The siloxane-modified derivatives of non-siloxane compounds are exemplified by silicon-modified acrylic resins corresponding to acrylic polymers (e.g., acrylic polymers containing hydroxy group(s) in a side chain), except for a polysiloxane chain (e.g., polydimethylsiloxane chain) being introduced; silicon-modified polyesters corresponding to polyesters, except for a polysiloxane chain being introduced; and silicon-modified polyurethanes corresponding to polyurethanes, except for a polysiloxane chain being introduced. The siloxane-modified derivatives of non-siloxane compounds may include the introduced polysiloxane chain at any position not critical. Typically, the polysiloxane chain may be introduced into a side chain, or into part of the principal chain, of non-siloxane compounds. The non-siloxane compounds are exemplified by acrylic polymers, polyesters, and polyurethanes. The siloxane-modified derivatives of non-siloxane compounds may each include hydroxy group(s) at any position(s) not critical. The hydroxy group(s) may be present in the non-siloxane compound moiety and/or in the modifying moiety (e.g., polysiloxane chain). The siloxane-modified derivatives of non-siloxane compounds may each include hydroxy group in a number not critical, as long as being one or more.

Of such hydroxy-containing silicon compounds, preferred are polyether-modified polysiloxanes, polyester-modified polysiloxanes, and silicon-modified acrylic resins. These are preferred from the points of the pencil hardness, scratch resistance, and appearance of the hard coat layer.

The curable composition for use in the present invention may include each of different hydroxy-containing silicon compounds alone or in combination. The hydroxy-containing silicon compounds usable herein may also be selected from commercial products. Such commercial products containing hydroxy-containing silicon compounds are exemplified by products available under the trade names of BYK-SILCLEAN 3720, BYK-SILCLEAN 3700, and BYK 370 (each from Byk-Chemie GmbH).

The curable composition for use in the present invention may contain the hydroxy-containing silicon compound(s) in a content (blending proportion) not critical, but preferably 0.1 to 10 parts by weight, and more preferably 0.5 to 8 parts by weigh, per 100 parts by weight of 3,4,3′,4′-diepoxybicyclohexyl. When the curable composition contains two or more different hydroxy-containing silicon compounds, the “content” refers to the total content of them. The curable composition, if containing the hydroxy-containing silicon compound(s) in a content less than 0.1 part by weight, may cause the hard coat layer to have insufficient scratch resistance. In contrast, the curable composition, if containing the hydroxy-containing silicon compound(s) in a content greater than 10 parts by weight, may cause the hard coat layer to have an insufficient pencil hardness.

The silica fillers usable herein are exemplified by known or common silica fillers. The silica constituting the silica fillers is exemplified by, but not limited to, fused silica, crystalline silica, and high-purity synthetic silica.

Each of the silica fillers may have any shape not critical, such as spheroid, crushed, fibrous, needle-like, flaky, or whisker shape. Among such shapes, the spheroid shape is preferred from the viewpoint of transparency.

The silica fillers may each have an average particle diameter not critical, but preferably 1 to 300 nm, and more preferably 5 to 50 nm. The silica fillers, if having an average particle diameter less than 1 nm, may cause the hard coat layer to have pencil hardness and/or scratch resistance at insufficient levels. In contrast, the silica fillers, if having an average particle diameter greater than 300 nm, may cause the hard coat layer to have insufficient transparency. As used herein the term “average particle diameter” refers to a value (median diameter) of the particle diameter at 50% in a cumulative distribution measured by the laser diffraction and scattering method.

The silica fillers may have undergone a known or common surface treatment. The surface treatment is exemplified by a surface treatment with a coupling agent such as a silane coupling agent and a titanium coupling agent. The silane coupling agent is exemplified by epoxy-containing silane coupling agents such as 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane; and amino-containing silane coupling agents such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and N-(vinylbenzyl)-2-aminoethyl-3-aminopropyltrimethoxysilane hydrochloride. The surface treatment may be performed by a procedure as appropriately selectable from known or common procedures.

The curable composition for use in the present invention may include each of different silica fillers alone or in combination. The silica fillers usable herein may also be selected from commercial products. Such commercial products containing silica fillers are exemplified by those available under the trade names of MEK-ST, MEK-ST-L, MEK-ST-ZL, MEK-ST-UP, MIBK-ST, and PMA-ST (each from Nissan Chemical Industries, Ltd.).

The curable composition for use in the present invention may contain the silica filler(s) in a content (blending proportion) not critical, but preferably 5 to 60 parts by weight, and more preferably 10 to 50 parts by weight, per 100 parts by weight of 3,4,3′,4′-diepoxybicyclohexyl. When the curable composition contains two or more different silica fillers in combination, the “content” refers to the total content of them. The curable composition, if containing the silica filler(s) in a content less than 5 parts by weigh, may cause the hard coat layer to have pencil hardness and/or scratch resistance at insufficient levels. In contrast, the curable composition, if containing the silica filler(s) in a content greater than 60 parts by weight, may cause the hard coat layer to have insufficient transparency.

The curable composition for use in the present invention may include either one or both of the hydroxy-containing silicon compound(s) and the silica filler(s) as the component (B).

Component C

The component C in the curable composition for use in the present invention is an acid generator. The curable composition for use in the present invention, as including the component C as an essential component, can allow a polymerization reaction (curing reaction) of a curable compound in the curable composition to proceed efficiently typically upon application of heat and/or an active energy ray. The curable composition can thereby form a hard coat layer with good productivity, where the hard coat layer has high pencil hardness and high scratch resistance and still offers excellent transparency. The acid generator is exemplified by photoacid generators that generate an acid by light irradiation; and thermal acid generators that generate an acid by heating (heat application). Though not limited, the curable composition for use in the present invention can be used as a photocurable composition when including a photoacid generator as the component C; and can be used as a thermosetting composition when including a thermal acid generator as the component C.

The photoacid generators are exemplified by hexafluoroantimonate salts, pentafluorohydroxyantimonate salts, hexafluorophosphate salts, fluoroalkylfluorophosphate salts (e.g., tris(fluoroalkyl)trifluorophosphate salts), and hexafluoroarsenate salts. The photoacid generators usable herein may also be preferably selected from commercial products available typically under the trade names of: UVACURE 1590 (from DAICEL-CYTEC Company, Ltd.); CD-1010, CD-1011, and CD-1012 (each from Sartomer Company Inc. (U.S.A.)); IRGACURE 264 (from BASF SE); CIT-1682 (from Nippon Soda Co., Ltd.); CPI-101A and CPI-300PG (from San-Apro Ltd.).

Of these photoacid generators, particularly preferred are compounds (photoacid generators) each including a fluoroalkyl-containing anionic moiety and a cationic moiety. These are preferred for the hard coat layer to have significantly high pencil hardness. The fluoroalkyl-containing anionic moiety is exemplified by a fluoroalkylfluorophosphate ion, CF₃SO₃—, C₄F₉SO₃—, and B(C₆F₅)₄—, where the fluorophosphate ion is represented by Formula (2):

[(Rf)ₙPF₆₋ₙ]⁻ (2)

where Rf represents a C₁-C₄ alkyl group (fluoroalkyl group) with fluorine atoms replacing 80% or more of hydrogen atoms; and n represents an integer of 1 to 5. Among them, the fluoroalkylfluorophosphate ion represented by Formula (2) is preferred as the fluoroalkyl-containing anionic moiety, because of excellent safety and curability.

In Formula (2), Rf is a C₁-C₄ alkyl group (fluoroalkyl group) with fluorine atoms replacing 80% or more of hydrogen atoms. In particular, Rf is typically preferably a straight- or branched-chain C₁-C₄ alkyl group (C₁-C₄ perfluoroalkyl group) with fluorine atoms replacing 100% (all) of hydrogen atoms. The C₁-C₄ perfluoroalkyl group is exemplified by CF₃—, C₂F₅—, (CF₃)₂CF—, C₃F₇—, C₄F₉—, (CF₃)₂CFCF₂—, CF₃CF₂ (CF₃) CF—, and (CF₃)₃C—.

Accordingly, the anionic moiety of the photoacid generator is particularly preferably selected typically from [(C₂F₅)₃PF₃], [(C₃F₇)₃PF₃], [((CF₃)₂CF)³PF₃], [((CF₃)₂CF)₂PF₄], [((CF₃)₂CFCF₂)₃PF₃]⁻, and [((CF₃)₂CFCF₂)₂PF₄]⁻.

The cationic moiety in the photoacid generator is exemplified by iodonium ions and sulfonium ions. Of the iodonium ions, aryliodonium ions are preferred, and bisaryliodonium ions are more preferred. Of the sulfonium ions, arylsulfonium ions are preferred, and triarylsulfonium ions are more preferred.

More specifically, the iodonium ions are exemplified by aryliodonium ions such as diphenyliodonium ion, di-p-tolyliodonium ion, bis(4-dodecylphenyl)iodonium ion, bis(4-methoxyphenyl)iodonium ion, (4-octyloxyphenyl)phenyliodonium ion, bis(4-decyloxy)phenyliodonium ion, 4-(2-hydroxytetradecyloxyphenyl)phenyliodonium ion, 4-isopropylphenyl(p-tolyl)iodonium ion, and 4-isobutylphenyl(p-tolyl)iodonium ion, of which bisaryliodonium ions are specially preferred.

The sulfonium ions are more specifically exemplified by arylsulfonium ions such as triphenylsulfonium ion, diphenyl[4-(phenylthio)phenyl]sulfonium ion, and tri-p-tolylsulfonium ion, of which triarylsulfonium ions are specially preferred.

Of such photoacid generators, particularly preferred examples include 4-isopropylphenyl(p-tolyl)iodonium tris(pentafluoroethyl)trifluorophosphate and [1,1′-biphenyl]-4-yl[4-(1,1′-biphenyl)-4-ylthiophenyl]phenylsulfonium tris(pentafluoroethyl)trifluorophosphate.

The thermal acid generators are exemplified by thermal cationic polymerization initiators such as aryldiazonium salts, aryliodonium salts, arylsulfonium salts, and arene-ion complexes. The thermal acid generators are further exemplified by compounds between a chelate compound and a silanol; and compounds between the chelate compound and a phenol. The chelate compound is exemplified by a chelate compound of a metal (e.g., aluminum or titanium) with acetoacetic acid or a diketone. The silanol is exemplified by triphenylsilanol. The phenol is exemplified by bisphenol-S. The thermal acid generators usable herein may also be selected from commercial products available typically under the trade names of: PP-33, CP-66, and CP-77 (each from ADEKA CORPORATION); FC-509 (from 3M Company); UVE1014 (from G.E.); San-Aid SI-60L, San-Aid SI-80L, San-Aid SI-100L, San-Aid SI-110L, and San-Aid SI-150L (from SANSHIN CHEMICAL INDUSTRY CO., LTD.); and CG-24-61 (from BASF SE).

The curable composition for use in the present invention may include one or more different acid generators alone or in combination.

The curable composition for use in the present invention may contain the acid generator(s) in a content (blending proportion) not critical, but preferably 0.1 to 10 parts by weight, and more preferably 0.2 to 5 parts by weight, per 100 parts by weight of 3,4,3′,4′-diepoxybicyclohexyl. When the curable composition contains two or more different acid generators, the “content” refers to the total content of them. The curable composition, if containing the acid generator(s) in a content less than 0.1 part by weight, may cause the curing reaction to proceed insufficiently and may thereby cause the hard coat layer to have poor properties such as pencil hardness and/or scratch resistance. In contrast, the curable composition, if containing the acid generator(s) in a content greater than 10 parts by weight, may cause the hard coat layer to have a poor appearance due typically to coloration.

The curable composition for use in the present invention may further include one or more additional components such as a solvent and an additive, in addition to the essential components (the components A, B, and C).

The solvent can be selected as appropriate in consideration typically of the solubility of the components A, B, and C, and is exemplified by, but not limited to, esters such as ethyl acetate, butyl acetate, and isobutyl acetate; ketones such as acetone, methyl ethyl ketone, methyl isobutyl ketone, diisobutyl ketone, and cyclohexanone; ethers such as ethylene glycol monomethyl ether; glycol monoether acetates such as diethylene glycol monobutyl ether acetate and propylene glycol monomethyl ether acetate; hydrocarbons such as xylenes and toluene; and mixtures of them.

The curable composition for use in the present invention may contain the solvent in a content (blending proportion) not critical, but preferably 0 to 95 percent by weight, more preferably 5 to 90 percent by weight, and furthermore preferably 10 to 80 percent by weight, based on the total amount (100 percent by weight) of the curable composition.

The additive usable herein as needed is exemplified by fillers excluding the silica fillers, dyestuffs, pigments, ultraviolet absorbers, photostabilizers, antifoaming agents, dispersing agents, and thixotropy imparting agents. The curable composition may contain the additive(s) in a content not critical, but preferably 0 to 10 parts by weight, and more preferably 0.05 to 5 parts by weight, per 100 parts by weight of 3,4,3′,4′-diepoxybicyclohexyl.

The curable composition for use in the present invention can be prepared typically by uniformly mixing the components A, B, and C, and one or more optional components added as needed. The mixing may be performed using a known or common device such as planetary centrifugal mixers, planetary mixers, kneaders, and dissolvers.

The hard coat film [1] according to the present invention may be produced by forming a hard coat layer [1] in the present invention on or over at least one surface of the plastic substrate using the curable composition (hard-coating agent) for use in the present invention. The hard coat layer [1] in the present invention can be formed by a known or common process for forming a hard coat layer without limitation. Typically, the hard coat layer [1] can be formed by applying the curable composition for use in the present invention to a surface (at least one surface) of the plastic substrate, removing volatile components such as the solvent typically by heating according to necessity, applying an active energy ray (e.g., light) and/or heat to the resulting curable composition to thereby cure the curable composition. Specifically, the hard coat film [1] according to the present invention may be produced by a method including the steps of applying the curable composition for use in the present invention to a surface (at least one surface) of the plastic substrate, and curing the applied curable composition as essential steps.

The application of the curable composition for use in the present invention to the plastic substrate may be performed by a known or common device or process not limited. Typically, the application can be performed using a known or common coating device such as a bar coater, spin coater, gravure coater, reverse roll coater, kiss-roll coater, roll knife coater, die coater, or rod coater. Conditions for the volatile components removal and for the application of heat and/or an active energy ray upon curing are not critical and can be set as appropriate according typically to the formulation of the curable composition and the type of the acid generator. For example, the application of an ultraviolet ray selected as the active energy ray may be performed typically using a light source such as a high-pressure mercury lamp, ultra-high pressure mercury lamp, carbon arc lamp, xenon lamp, or metal halide lamp. In general, an irradiation source having a lamp output of about 80 to about 300 W/cm may be used. On the other hand, the application of electron beams selected as the active energy ray can be performed generally using electron beams having energy in the range of 50 to 1000 keV at an irradiance of 2 to 5 Mrad. The application of an active energy ray and the application of heat (heating) may be employed in combination. Typically, heating may be performed according to necessity after the active energy ray application, so as to accelerate the curing.

The hard coat layer [1] in the present invention in the hard coat film [1] according to the present invention preferably includes, as surface elements, silicon and at least one element selected from the group consisting of sulfur, phosphorus, fluorine, and antimony. The surface elements are elements constituting the surface of the hard coat layer and are analyzed by ESCA (XPS; X-ray photoelectron spectroscopy). The presence of silicon in the surface elements constitutes the evidence of the use of the component B as a component of the curable composition (hard-coating agent). The presence of at least one element selected from the group consisting of sulfur, phosphorus, fluorine, and antimony in the surface elements constitutes the evidence of the use of, as the component C, an acid generator including at least one of these elements as a constituent element. The component C as above, when used, may readily allow the hard coat layer [1] in the present invention to be formed efficiently by light irradiation and to have still higher surface hardness. The ESCA can be performed typically using Physical Electronics PHI 5800 ESCA System (trade name, supplied by ULVAC-PHI, Inc.) as a measuring apparatus.

In contrast, the hard coat layer [2] in the present invention in the hard coat film [2] according to the present invention is a hard coat layer that has ratios a2/a1 and a3/a1 controlled within specific ranges, where the ratios are of absorbances measured based on an attenuated total reflection infrared spectroscopic spectrum (ATR-IR spectrum) of the surface of the hard coat layer. Specifically, the ratio a2/a1 is 0.1 or less (preferably 0 to 0.05, and more preferably 0.03 or less); and the ratio a3/a1 is 0.1 or less (preferably 0 to 0.05, and more preferably 0.03 or less). The a1 represents the absorbance of an absorption peak assigned to an ether bond C—O stretching vibration, where the absorption peak generally appears at about 1050 to about 1100 cm⁻¹. The a2 represents the absorbance of an absorption peak assigned to an ester bond C═O stretching vibration, where the absorption peak generally appears at about 1700 to about 1750 cm⁻¹. The a3 represents the absorbance of an absorption peak assigned to an aromatic C—H out-of-plane bending vibration, where the absorption peak generally appears at about 700 to about 800 cm⁻¹. The ATR-IR spectrum may be measured typically using Infrared Spectrometer FT-720 (trade name, supplied by HORIBA, Ltd.) as a measuring apparatus at a measuring power of 4 cm⁻¹, a number of scans of 16, and a measuring gain of 2.

Assume that the hard-coating agent (curable composition) to form the hard coat layer [2] in the present invention includes a large amount of an ester-bond-containing component (e.g., ester-bond-containing epoxy compound) as a component. In this case, the ratio a2/a1 may generally be greater than 0.1. Also assume that the hard-coating agent includes a large amount of an aromatic-ring-containing component (e.g., aromatic-ring-containing epoxy compound) as a component. In this case, the ratio a3/a1 may generally be greater than 0.1. In these cases, the resulting cured product may have pencil hardness and/or transparency at insufficient level.

The hard coat layer [2] in the present invention includes, as surface elements, at least one element selected from the group consisting of sulfur, phosphorus, fluorine, and antimony, where the surface elements are analyzed by ESCA of the surface of the hard coat layer. The presence of at least one element selected from the group consisting of sulfur, phosphorus, fluorine, and antimony in the surface elements constitutes the evidence of the use of an acid generator including at least one of these elements as a constituent element. The acid generator is exemplified by the component C in the hard coat layer [1] in the present invention. The acid generator of this type, when used, may readily allow the hard coat layer [2] in the present invention to be formed efficiently by light irradiation and to have still higher surface hardness. The surface elements constituting the surface of the hard coat layer [2] in the present invention preferably further include silicon, where the surface elements are analyzed by ESCA of the surface of the hard coat layer. In particular, the presence of silicon in the surface elements constitutes the evidence of the use of a silicon-containing compound, in particular, the component B in the hard coat layer [1] in the present invention, as a component of the hard coat layer [2] in the present invention. The hard coat layer [2] in the present invention, when including silicon as above, may exhibit excellent scratch resistance. The ESCA can be performed typically using Physical Electronics PHI 5800 ESCA System (trade name, supplied by ULVAC-PHI, Inc.) as a measuring apparatus.

The hard coat layer [2] in the present invention in the hard coat film [2] according to the present invention has high pencil hardness and still offers excellent transparency. This is because the hard coat layer [2] has specific ratios between the absorbances as calculated based on the surface ATR-IR spectrum. More specifically, this is probably because the hard coat layer includes at least an ether bond, includes none or a very small amount of an ester bond, and includes none or a very small amount of an aromatic ring, where the ether bond is formed by cationic polymerization (ring-opening polymerization) of a cyclic ether compound such as an epoxy compound. In an embodiment, the hard coat layer [2] further includes silicon in the surface elements as analyzed by ESCA. The hard coat layer in this embodiment further has excellent scratch resistance. The hard coat layer [2] in the present invention in the hard coat film [2] according to the present invention may be formed typically using a hard-coating agent corresponding to the curable composition (curable composition to form the hard coat layer [1] in the present invention), except for controlling, for example, the proportions of 3,4,3′,4′-diepoxybicyclohexyl, an ester-bond-containing component, and an aromatic-ring-containing component. The curable composition to form the hard coat layer [2] in the present invention not always has to include a silicon-containing compound (e.g., the component B).

The hard coat layer in the present invention may have a thickness not critical, but preferably 20 μm or more, and more preferably 30 μm or more. In particular, the hard coat layer in the present invention is resistant to defects such as crack formation caused typically by cure shrinkage upon curing, even when having a large thickness (e.g., having a thickness of 30 μm or more). The hard coat layer can thereby have significantly high pencil hardness (e.g., have pencil hardness of 6H or higher) by having a large thickness. The upper limit of the thickness of the hard coat layer in the present invention is not critical, but typically preferably 2 mm, and more preferably 1 mm.

The hard coat layer in the present invention may have a haze not critical, but preferably 1.5% or less, and more preferably 1.0% or less at a thickness of 30 μm. The lower limit of the haze is not critical, but typically 0.1%. The hard coat layer, if having a haze greater than 1.5%, may be unsuitable for uses where extremely high transparency is required. Such uses are exemplified by surface protecting sheets for displays typically of touch panels. The haze of the hard coat layer in the present invention may be measured in conformity to JIS K 7136.

The hard coat layer in the present invention may have a total luminous transmittance not critical, but preferably 85% or more, and more preferably 90% or more at a thickness of 30 μm. The upper limit of the total luminous transmittance is not critical, but typically 99%. The hard coat layer, if having a total luminous transmittance less than 85%, may be unsuitable typically for uses where extremely high transparency is required. The uses are exemplified by surface protecting sheets for displays typically of touch panels. The total luminous transmittance of the hard coat layer in the present invention may be measured in conformity to JIS K 7361-1.

The hard coat film according to the present invention may have a thickness that is not critical, but is selectable as appropriate within the range of 0.01 to 10000 μm.

The hard coat layer in the present invention in the hard coat film according to the present invention may have surface pencil hardness not critical, but preferably 3H or higher, and more preferably 5H or higher. The pencil hardness may be evaluated in conformity to the method described in JIS K 5600.

The hard coat film according to the present invention may have a haze not critical, but preferably 1.5% or less, and more preferably 1.0% or less. The lower limit of the haze is not critical, but typically 0.1%. The hard coat film, if having a haze greater than 1.5%, may be unsuitable for uses where extremely high transparency is required. The uses are exemplified by surface protecting sheets for displays typically of touch panels. The haze of the hard coat film according to the present invention can be easily controlled within the range typically using any of the transparent substrates as the plastic substrate. The haze can be measured in conformity to JIS K 7136.

The hard coat film according to the present invention may have a total luminous transmittance not critical, but preferably 85% or more, and more preferably 90% or more. The upper limit of the total luminous transmittance is not critical, but typically 99%. The hard coat film, if having a total luminous transmittance less than 85%, may be unsuitable for uses where extremely high transparency is required. The uses are exemplified by surface protecting sheets for displays typically of touch panels. The total luminous transmittance of the hard coat film according to the present invention can be easily controlled within the range typically using any of the transparent substrates as the plastic substrate. The total luminous transmittance may be measured in conformity to JIS K 7361-1.

The hard coat film according to the present invention includes the hard coat layer as a surface layer, where the hard coat layer has high pencil hardness and high scratch resistance, still offers excellent transparency, and can have significantly high pencil hardness by having a large thickness. The hard coat film is thereby preferably usable particularly in uses of every type where such properties are required. The hard coat film according to the present invention is usable typically as surface-protecting films in various products; as surface-protecting films in members or parts of various products; and as components of various products and as components of members or parts of such products. The products are exemplified by display devices such as liquid crystal displays and organic electroluminescent displays; input devices such as touch panels; solar cells; various household electrical appliances; various electrical/electronics products; portable electronic terminals such as game equipment, personal computers, tablets (tablet computers), smartphones, and cellular phones; and various optical equipment. In embodiments, the hard coat film according to the present invention is used as components of various products, or of members or parts of the products. For example, in an embodiment, the hard coat film is used typically to constitute an assembly (laminate) of the hard coat film and a transparent conductive film in a touch panel.

### EXAMPLES

The present invention will be illustrated in further detail with reference to several examples below. It should be noted, however, that the examples are by no means intended to limit the scope of the present invention. The blending proportions of components of curable compositions given in Table 1 are indicated in part by weight. Of the components given in Table 1, the blending proportion of a commercial product is indicated as the amount (blending proportion) of the commercial product itself.

### Example 1

A mixed solution was prepared and used as a hard-coating liquid (curable composition). The mixed solution included, as shown in Table 1, 100 parts by weight of 3,4,3′,4′-diepoxybicyclohexyl, 4 parts by weight of BYK-SILCLEAN 3720 (trade name, supplied by Byk-Chemie GmbH), and 0.5 part by weight of CPI-300PG (trade name, supplied by San-Apro Ltd.). The BYK-SILCLEAN 3720 is a solution of a hydroxy-containing polyether-modified polydimethylsiloxane and has a non-volatile content of 25 percent by weight. The CPI-300PG is a solution containing a photoacid generator and has a non-volatile content of 50 percent by weight.

The obtained hard-coating liquid was applied to a surface of a PET film that carried a hard coat layer on the other surface. The application was performed by flow casting using a wire bar #30. The resulting workpiece was left stand in an oven at 80° C. for one minute and irradiated with an ultraviolet ray under an irradiation condition of 290 mJ/cm². The workpiece was finally subjected to a heat treatment at 150° C. for one hour to cure the applied layer of the hard-coating liquid, and thereby yielded a hard coat film including a 41-μm thick hard coat layer.

As shown in Table 1, the obtained hard coat film had a haze of 0.5%, a total luminous transmittance of 91.3%, pencil hardness (pencil hardness of the surface of the above-formed hard coat layer side) of 6H, and a number of scratches formed in a scratch resistance test of zero (0). The results are shown in Table 1. Details of evaluation procedures of these properties will be described later.

The surface of the hard coat layer (the above-formed hard coat layer) in the obtained hard coat film was examined to measure an ATR-IR spectrum using Infrared Spectrometer FT-720 (trade name, supplied by HORIBA, Ltd.) as a measuring apparatus and using a diamond prism (supplied by SensIR Technologies LLC). Upon the measurement of absorbances based on the obtained ATR-IR spectrum chart, a base line was taken in the range of 1700 to 400 cm⁻¹.

The ratios a2/a1 and a3/a1 were calculated from the ATR-IR spectrum chart and found to be each 0.1 or less.

ESCA measurement was performed on the surface of the hard coat layer (the above-formed hard coat layer) in the obtained hard coat film using a measuring apparatus below. This revealed that the hard coat layer included, as surface elements, silicon, sulfur, phosphorus, fluorine, carbon, and oxygen.

The measuring apparatus was Physical Electronics PHI 5800 ESCA System (trade name, supplied by ULVAC-PHI, Inc.)

### Example 2

A mixed solution was prepared and used as a hard-coating liquid (curable composition). The mixed solution included, as shown in Table 1, 100 parts by weight of 3,4,3′,4′-diepoxybicyclohexyl, 4 parts by weight of BYK-SILCLEAN 3700 (trade name, supplied by Byk-Chemie GmbH), and 0.5 part by weight of CPI-300PG (trade name). The BYK-SILCLEAN 3700 is a solution of a hydroxy-containing silicon-modified acryl and has a non-volatile content of 25 percent by weight.

Next, a hard coat film including a 40-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which ratios a2/a1 and a3/a1 were calculated and found to be each 0.1 or less.

ESCA measurement was performed on the surface of the hard coat layer (the above-formed hard coat layer) in the obtained hard coat film using the measuring apparatus. This revealed that the hard coat layer included, as surface elements, silicon, sulfur, phosphorus, fluorine, carbon, and oxygen.

### Example 3

A mixed solution was prepared and used as a hard-coating liquid (curable composition). The mixed solution included, as shown in Table 1, 100 parts by weight of 3,4,3′,4′-diepoxybicyclohexyl, 4 parts by weight of BYK 370 (trade name, supplied by Byk-Chemie GmbH), and 0.5 part by weight of CPI-300PG (trade name). The BYK 370 is a solution of a hydroxy-containing polyester-modified polydimethylsiloxane and has a non-volatile content of 25 percent by weight.

Next, a hard coat film including a 41-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which ratios a2/a1 and a3/a1 were calculated and found to be each 0.1 or less.

ESCA measurement was performed on the surface of the hard coat layer (the above-formed hard coat layer) in the obtained hard coat film using the measuring apparatus. This revealed that the hard coat layer included, as surface elements, silicon, sulfur, phosphorus, fluorine, carbon, and oxygen.

### Example 4

A mixed solution was prepared and used as a hard-coating liquid (curable composition). The mixed solution included, as shown in Table 1, 100 parts by weight of 3,4,3′,4′-diepoxybicyclohexyl, 33 parts by weight of MEK-ST (trade name, supplied by Nissan Chemical Industries, Ltd.), and 5 parts by weight of CPI-300PG5 (trade name). The MEK-ST is a dispersion including a silica filler and has a solids content of 30 percent by weight and an average particle diameter (BET method) of the silica filler of 10 to 15 nm.

A hard coat film including a 55-μm thick hard coat layer was prepared by the procedure of Example 1, except for using the above-obtained hard-coating liquid and using a wire bar #20. Evaluation results on the hard coat film are shown in Table 1.

An ATR-IR spectrum of the surface of the hard coat layer (the above-formed hard coat layer) in the obtained hard coat film was measured, based on which ratios a2/a1 and a3/a1 were calculated and found to be each 0.1 or less.

ESCA measurement was performed on the surface of the hard coat layer (the above-formed hard coat layer) in the obtained hard coat film using the measuring apparatus. This revealed that the hard coat layer included, as surface elements, silicon, sulfur, phosphorus, fluorine, carbon, and oxygen.

### Example 5

A mixed solution was prepared and used as a hard-coating liquid (curable composition). The mixed solution included, as shown in Table 1, 100 parts by weight of 3,4,3′,4′-diepoxybicyclohexyl and 0.5 part by weight of CPI-300PG (trade name).

A hard coat film including a 35-μm thick hard coat layer was prepared by the procedure of Example 1, except for using the above-obtained hard-coating liquid. Evaluation results on the hard coat film are shown in Table 1.

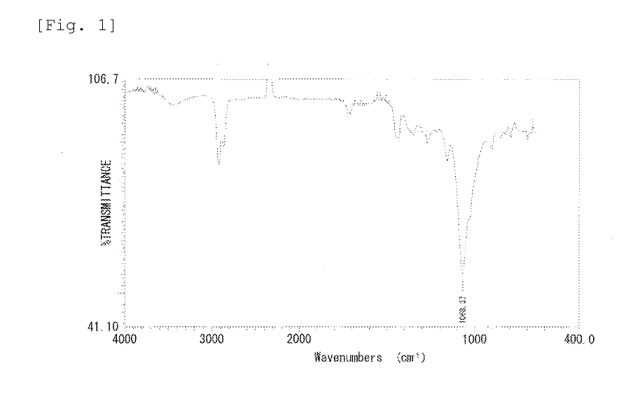

The ATR-IR spectrum chart of the surface of the hard coat layer (the above-formed hard coat layer) in the obtained hard coat film is illustrated in FIG. 1. In the ATR-IR spectrum, an absorption peak at 1068.37 cm⁻¹ is an absorption peak assigned to an ether bond C—O stretching vibration. There were not observed an absorption peak assigned to an aromatic C—H out-of-plane bending vibration and an absorption peak assigned to an ester bond C═O stretching vibration. Specifically, ratios a2/a1 and a3/a1 were found to be each 0.1 or less, where the ratios were calculated from absorbances of the absorption peaks.

ESCA measurement was performed on the surface of the hard coat layer (the above-formed hard coat layer) in the obtained hard coat film using the measuring apparatus. This revealed that the hard coat layer included, as surface elements, sulfur, phosphorus, fluorine, carbon, and oxygen.

### Example 6

A mixed solution was prepared and used as a hard-coating liquid (curable composition). The mixed solution included, as shown in Table 1, 100 parts by weight of 3,4,3′,4′-diepoxybicyclohexyl and 0.5 part by weight of CPI-300PG (trade name).

A hard coat film including a 12-μm thick hard coat layer was prepared by the procedure of Example 1, except for using the above-obtained hard-coating liquid and using a wire bar #20. Evaluation results on the hard coat film are shown in Table 1.

An ATR-IR spectrum of the surface of the hard coat layer (the above-formed hard coat layer) in the obtained hard coat film was measured, based on which ratios a2/a1 and a3/a1 were calculated and found to be each 0.1 or less.

ESCA measurement was performed on the surface of the hard coat layer (the above-formed hard coat layer) in the obtained hard coat film using the measuring apparatus. This revealed that the hard coat layer included, as surface elements, sulfur, phosphorus, fluorine, carbon, and oxygen.

### Comparative Example 1

A mixed solution was prepared and used as a hard-coating liquid (curable composition). The mixed solution included, as shown in Table 1, 100 parts by weight of CELLOXIDE 2021P (trade name, 3,4-epoxycyclohexylmethyl(3,4-epoxy)cyclohexanecarboxylate, supplied by Daicel Corporation) and 0.5 part by weight of CPI-300PG (trade name).

A hard coat film including a 36-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which a ratio a2/a1 was calculated and found to be greater than 0.1. This is because of using a component containing an ester bond in molecule (CELLOXIDE 2021P) as a component of the hard-coating liquid.

### Comparative Example 2

A mixed solution was prepared and used as a hard-coating liquid (curable composition). The mixed solution included, as shown in Table 1, 100 parts by weight of DPHA (trade name, supplied by DAICEL-CYTEC Company, Ltd.) and 2 parts by weight of Irgacure 184 (trade name, a photo-radical polymerization initiator supplied by BASF SE). The DPHA is a mixture of dipentaerythritol pentaacrylate and dipentaerythritol hexaacrylate.

A hard coat film including a 38-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which a ratio a2/a1 was calculated and found to be greater than 0.1. This is because of using a component containing an ester bond in molecule (DPHA) as a component of the hard-coating liquid. ESCA measurement was performed on the surface of the hard coat layer (the above-formed hard coat layer) in the obtained hard coat film using the measuring apparatus. This revealed that the hard coat layer included, as surface elements, none of sulfur, phosphorus, and fluorine.

### Comparative Example 3

A mixed solution was prepared and used as a hard-coating liquid (curable composition). The mixed solution included, as shown in Table 1, 100 parts by weight of CELLOXIDE 2021P (trade name), 4 parts by weight of BYK-SILCLEAN 3720 (trade name), and 0.5 part by weight of CPI-300PG (trade name).

A hard coat film including a 39-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which a ratio a2/a1 was calculated and found to be greater than 0.1. This is because of using a component containing an ester bond in molecule (CELLOXIDE 2021P) as a component of the hard-coating liquid.

### Comparative Example 4

A mixed solution was prepared and used as a hard-coating liquid (curable composition). The mixed solution included, as shown in Table 1, 100 parts by weight of CELLOXIDE 2021P (trade name), 4 parts by weight of BYK-SILCLEAN 3700 (trade name), and 0.5 part by weight of CPI-300PG (trade name).

A hard coat film including a 42-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which a ratio a2/a1 was calculated and found to be greater than 0.1. This is because of using a component containing an ester bond in molecule (CELLOXIDE 2021P) as a component of the hard-coating liquid.

### Comparative Example 5

A mixed solution was prepared and used as a hard-coating liquid (curable composition). The mixed solution included, as shown in Table 1, 100 parts by weight of CELLOXIDE 2021P (trade name), 4 parts by weight of BYK 370 (trade name), and 0.5 part by weight of CPI-300PG (trade name).

A hard coat film including a 41-μm thick hard coat layer was prepared by the procedure of Example 1, except for using the above-obtained hard-coating liquid. Evaluation results on the hard coat film are shown in Table 1.

An ATR-IR spectrum of the surface of the hard coat layer (the above-formed hard coat layer) in the obtained hard coat film was measured, based on which a ratio a2/a1 was calculated and found to be greater than 0.1. This is because of using a component containing an ester bond in molecule (CELLOXIDE 2021P) as a component of the hard-coating liquid.

The hard coat films obtained in the examples and comparative examples were evaluated by procedures as follows.

### Haze and Total Luminous Transmittance Measurement

The haze and total luminous transmittance of each of the hard coat films obtained in the examples and comparative examples were measured in conformity to JIS K 7361-1 and JIS K 7136 using a haze meter.

### Pencil Hardness Evaluation

The pencil hardness of the formed hard coat layer surface in each of the hard coat films obtained in the examples and comparative examples was evaluated in conformity to JIS K 5600.

In Comparative Example 2, the hard coat layer underwent cracking, and this disabled the pencil hardness evaluation. The pencil hardness evaluation result of Comparative Example 2 is thereby indicated as “-” in Table 1.

### Scratch Resistance Test

A test was performed on the formed hard coat layer surface of each of the hard coat films obtained in the examples and comparative examples. In the test, the surface was rubbed by ten reciprocating movements of a #0000 steel wool at a load of 1.3 kg/cm². The hard coat layer surface after the test was visually observed, scratches formed on the surface were counted, and the scratch resistance was evaluated according to criteria mentioned below.

In Comparative Example 2, the formed hard coat layer had cracking, and this disabled the scratch resistance test. The scratch resistance evaluation result of Comparative Example 2 is thereby indicated as “-” in Table 1.

A (very good scratch resistance): No scratch was formed on the hard coat layer surface;

B (good scratch resistance): One to five scratches were formed on the hard coat layer surface;

C (poor scratch resistance): Six to ten scratches were formed on the hard coat layer surface; and

D (very poor scratch resistance): Eleven or more scratches were formed on the hard coat layer surface.

### Appearance Evaluation

The formed hard coat layer surface of each of the hard coat films obtained in the examples and comparative examples was examined by visual observation. A sample suffering from cracking on the hard coat layer was evaluated as “poor” (poor appearance); and a sample suffering from no cracking on the hard coat layer was evaluated as “good” (good appearance).

TABLE 1

| | | | Example 1 | Example 2 | Example 3 | Example 4 | Example 5 | Example 6 |
|---|---|---|---|---|---|---|---|---|
| Curable | Curable compound | 3,4,3′,4′- | 100 | 100 | 100 | 100 | 100 | 100 |
| composition | | Diepoxybicyclohexyl | | | | | | |
| | | CELLOXIDE 2021P | — | — | — | — | — | — |
| | | DPHA | — | — | — | — | — | — |
| | Hydroxy-containing | BYK-SILCLEAN 3720 | 4 | — | — | — | — | — |
| | silicon compound | BYK-SILCLEAN 3700 | — | 4 | — | — | — | — |
| | | BYK 370 | — | — | 4 | — | — | — |
| | Initiator | CPI-300PG | 0.5 | 0.5 | 0.5 | 5 | 0.5 | 0.5 |
| | | Irgacure 184 | — | — | — | — | — | — |
| | Silica filler | MEK-ST | — | — | — | 33 | — | — |

| | | | | | | | |
|---|---|---|---|---|---|---|---|
| Evaluation | Hard coat layer thickness [mm] | 41 | 40 | 41 | 55 | 35 | 12 |
| | Haze [%] | 0.5 | 0.5 | 0.5 | 1.1 | 1.6 | 0.5 |
| | Total luminous transmittance [%] | 91.3 | 91.2 | 91.1 | 90.0 | 90.0 | 89.9 |
| | Pencil hardness | 6H | 6H | 6H | 8H | 5H | 3H |
| | Scratch resistance (1.3 kg/cm²) | A | B | A | C | D | C |
| | Appearance | Good | Good | Good | Good | Good | Good |

| | | | Com. Ex. 1 | Com. Ex. 2 | Com. Ex. 3 | Com. Ex. 4 | Com. Ex. 5 |
|---|---|---|---|---|---|---|---|
| Curable | Curable compound | 3,4,3′,4′- | — | — | — | — | — |
| composition | | Diepoxybicyclohexyl | | | | | |
| | | CELLOXIDE 2021P | 100 | — | 100 | 100 | 100 |
| | | DPHA | — | 100 | — | — | — |
| | Hydroxy-containing | BYK-SILCLEAN 3720 | — | — | 4 | — | — |
| | silicon compound | BYK-SILCLEAN 3700 | — | — | — | 4 | — |
| | | BYK 370 | — | — | — | — | 4 |
| | Initiator | CPI-300PG | 0.5 | — | 0.5 | 0.5 | 0.5 |
| | | Irgacure 184 | — | 2 | — | — | — |
| | Silica filler | MEK-ST | — | — | — | — | — |

| | | | | | | |
|---|---|---|---|---|---|---|
| Evaluation | Hard coat layer thickness [mm] | 36 | 38 | 39 | 42 | 41 |
| | Haze [%] | 0.8 | 2.1 | 0.7 | 0.5 | 0.5 |
| | Total luminous transmittance [%] | 90.0 | 90.0 | 90.1 | 90.2 | 89.9 |
| | Pencil hardness | 3H | — | 3H | 3H | 3H |
| | Scratch resistance (1.3 kg/cm²) | D | — | C | C | C |
| | Appearance | Good | Poor | Good | Good | Good |

As indicated in Table 1, the hard coat films [1] according to the present invention (Examples 1 to 4) had excellent transparency, still had high pencil hardness, and offered excellent scratch resistance. The hard coat films [1] did not suffer from defects such as crack formation and had excellent appearances even though having a relatively thick (about 40 μm or 55 μm thick) hard coat layer. Examples 1 to 4 correspond to hard coat films [2] according to the present invention in which the hard coat layer [2] in the present invention contains silicon atom. On the other hand, of hard coat films [2] according to the present invention, those including no silicon atom in the hard coat layer [2] in the present invention (Examples 5 and 6; excluded from the hard coat films [1] according to the present invention) had excellent transparency and still had high pencil hardness although having poor scratch resistance. In particular, Example 6 had a relatively high pencil hardness even though having a very thin hard coat. In this connection, hard coat films having high pencil hardness, even if having very poor scratch resistance, may be usable without any trouble in some uses.

In contrast, samples (comparative examples) not meeting conditions specified in the present invention had low, insufficient pencil hardness. In the comparative examples, the component A was not used, or the ratio a2/a1 was grater than 0.1. A hard-coating liquid formed by radical polymerization as in Comparative Example 2, when used so as to form a hard coat layer having a thickness of about 40 μm, failed to form the target hard coat layer because of cracking due to cure shrinkage.

### INDUSTRIAL APPLICABILITY

The hard coat film according to the present invention is usable typically as surface-protecting films in various products; and as surface-protecting films in members or parts of the products. The hard coat film is also usable as components for various products, and components for members or parts of the products.

1. A hard coat film comprising:
a plastic substrate; and
a hard coat layer disposed on or over at least one surface of the plastic substrate,
wherein the hard coat layer is formed from a curable composition comprising:
3,4,3′,4′-diepoxybicyclohexyl;
at least one selected from the group consisting of hydroxy-containing silicon compounds and silica fillers; and
an acid generator.

2. The hard coat film according to claim 1,
wherein the hard coat layer has a thickness of 20 μm or more.

3. The hard coat film according to one of claims 1 and 2,
wherein the hard coat layer comprises surface elements comprising:
silicon; and
at least one element selected from the group consisting of sulfur, phosphorus, fluorine, and antimony,
where the surface elements are analyzed by ESCA of a surface of the hard coat layer.

4. The hard coat film according to claim 1,
wherein the hard coat film has a haze of 1.5% or less.

5. A method for producing the hard coat film according to claim 1, the method comprising the steps of:
applying a curable composition to a surface of a plastic substrate; and
curing the applied curable composition,
the curable composition comprising:
3,4,3′,4′-diepoxybicyclohexyl;
at least one selected from the group consisting of hydroxy-containing silicon compounds and silica fillers; and
an acid generator.

6. A hard coat film comprising:
a plastic substrate; and
a hard coat layer disposed on or over at least one surface of the plastic substrate,
wherein the hard coat layer has a ratio a2/a1 of 0.1 or less and a ratio a3/a1 of 0.1 or less,
where, in an ATR-IR spectrum of a surface of the hard coat layer, a1 represents an absorbance of an absorption peak assigned to an ether bond C—O stretching vibration; a2 represents an absorbance of an absorption peak assigned to an ester bond C═O stretching vibration; and a3 represents an absorbance of an absorption peak assigned to an aromatic C—H out-of-plane bending vibration, and
wherein the hard coat layer comprises surface elements comprising at least one element selected from the group consisting of sulfur, phosphorus, fluorine, and antimony, where the surface elements are analyzed by ESCA of a surface of the hard coat layer.

7. The hard coat film according to claim 6,
wherein the surface elements further comprise silicon, where the surface elements are analyzed by ESCA of the surface of the hard coat layer.
